(19) United States
(12) Patent Application Publication
(10) Pub. No.: US 2005/0158697 A1
(43) Pub. Date: Jul. 21, 2005

(54) System and method for providing customized, effective, risk based ethics and compliance training and information using a network

(75) Inventors: Carl Frederick Nelson, Weston, MA (US); Kirk Stephen Jordan, North Kingstown, RI (US)

Correspondence Address: MCCARTER & ENGLISH, LLP, FOUR GATEWAY CENTER, 100 MULBERRY STREET, NEWARK, NJ, 07102, US

(73) Assignee: Integrity Interactive

(21) Appl. No.: 10/757,953

(22) Filed: Jan. 15, 2004

(51) Int. Cl. G09B 3/00

(52) U.S. Cl. 434/350

(57) ABSTRACT

An Internet compliance training system having a relational database for storing training data and a server for connecting to user computers through the Internet to provide training by presenting the training data, such as text, audio and image files. The training data is prepared with the training needs of specific users and groups of users in mind, with the purpose of providing training in those areas that the specific trainees can use to avoid risk of non-compliance. When a user signs-on, the system recognizes them and provides customized training content to them. The system is interactive with the trainee, giving the trainee control over presentation rate and order, such that the custom content is retrieved and delivered dynamically. The system has a subscription management system to automatically email trainees to induce them to take and finish courses, a testing system to verify that trainees fully comprehend content and a tracking system that records the course content that trainees have taken. The system has a timer to prevent a trainee from clicking through a course without reviewing it.

### FIELD OF THE INVENTION

The present invention relates to systems and methods for presenting training or information on a computer. More particularly, the present invention relates to providing training courses and information concerning corporate ethics and compliance over the Internet in a manner that is customized, risk based, and effective.

### BACKGROUND OF THE INVENTION

The concept of providing educational instruction on a computer over the Internet has been implemented in the past. Notwithstanding, the known methods of providing such training and communications may be improved so as to meet certain standards of effectiveness, particularly in the area of instruction pertaining to the ethics and compliance of specific persons and groups of persons having a specific risk profile relative to various laws and standards as promulgated by society, through the legislature, courts and industry.

The demonstration of effective ethics and compliance training of employees by corporations can be of substantial value to such corporations, e.g., in meeting the requirements of the Federal Sentencing Guidelines, in complying with the, the Sarbanes-Oxley Act, and in reducing the risk of legal claims resulting from the failure of employees to observe laws and company policies in the area of compliance and ethics.

Such improvements in the effectiveness of ethics and compliance training and communications program would encompass the following attributes:
(a) That the training and communications be specific to the risks presented by the employee due to their industry, job duties, seniority, location or other relevant factors;
(b) That the program includes demonstration that the employee has completed and understands the training;
(c) That the training program be ongoing to maintain employee knowledge and awareness of ethics and compliance risks and the risk-management resources associated with their work; and
(d) That the training program includes tracking and reporting mechanisms to demonstrate, with a reliable and credible audit trail, that the employee has completed a particular training program on a particular date as part of an identifiable curriculum.

### SUMMARY OF THE INVENTION

The limitations of prior art methods and apparatus for providing automated instruction via a computer connected to a network are addressed by the present invention, which includes a system having a database for holding training data, a subset of the training data being targeted data for teaching at least one specific person having a specific training need, e.g., in an ethics or compliance topic or subject. A server computer connected to the network has access to the training data in the database and can recognize persons who connect to the system to obtain training. The recognition of user identity triggers the extraction of data targeted at them from the database and the presentation thereof by the server to train that specific person. In accordance with a method of the present invention, basic training data for training persons on a particular topic is identified. The particular characteristics of at least one specific person are considered and specific training data that will increase the awareness and understanding of the relevant topic, e.g., ethics and compliance information is identified. The basic training data and the specific training data are stored in a database, with the specific data being targeted for teaching the specific person having a specific training need. The basic training data and the specific training data are then presented to the trainee over the network via a server computer connected to the network and having access to the database.

### BRIEF DESCRIPTION OF THE FIGURES

FIG. 1 is a diagram showing a system in accordance with the present invention.

FIG. 2 is a diagram of the system of FIG. 1, but showing greater detail with regards to the processes relating to Ethics and Compliance Risk Analysis.

FIG. 3 is a flowchart of processing in accordance with the present invention.

FIG. 4 is a sample portal screen in accordance with the present invention.

FIG. 5 is a sample course menu screen in accordance with the present invention.

FIG. 6 is a sample course content screen illustrating various instructional options available to a person taking a course in accordance with the present invention.

### DETAILED DESCRIPTION OF THE INVENTION

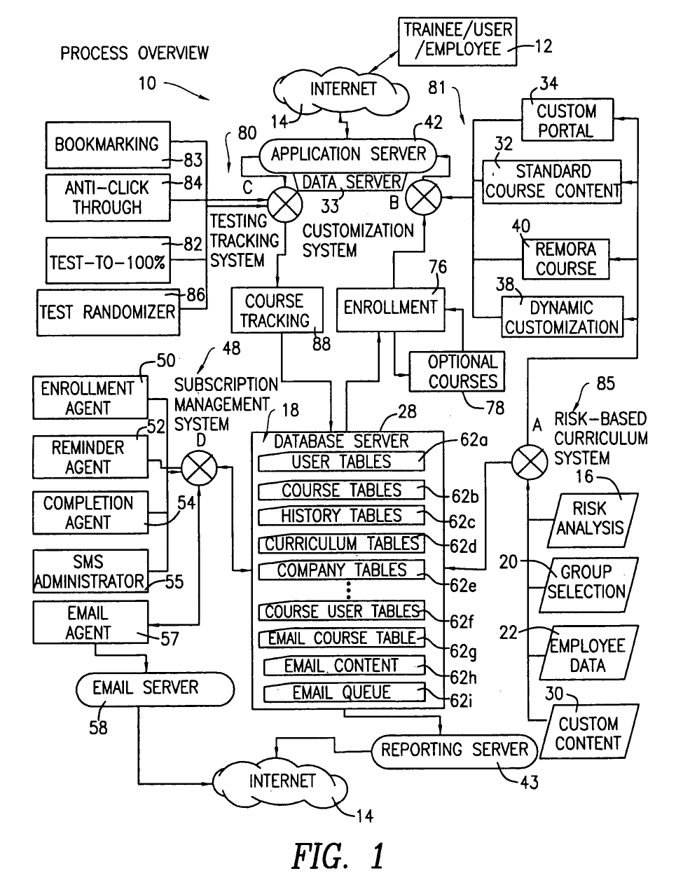

FIG. 1 shows a system 10 for providing training and instruction to trainees/users/employees 12 over the Internet 14. The system 10 contemplates a process for developing course content consistent with the needs, interests and preferences of the trainee 12 and/or the employer of the trainee 12. This training is typically in the area of “ethics” or “compliance” training, wherein employees, officers, directors, contractors and/or agents of a company are instructed in various policies, code of conduct, procedures, laws, treaties, and other rules and regulations which are relevant to their work activities. Topics such as Antitrust, Conflicts of Interest, Sexual Harassment, Privacy, Insider Trading and other ethics and compliance topics are exemplary subjects for training by the present invention. Of course, virtually any ethics or compliance information could be taught using the apparatus and methodology described herein. As shall be described below, the training or course content includes text, images, audio clips and diagrams, but could also include video clips, worksheets and the like. The various components of content may be used to set out an exemplary “story” illustrating the principles of the particular ethical principles or policies or compliance laws and rules covered by the course. For example, the system 10 may present an exemplary, chronological story concerning a fictional or actual individual's experiences that brought them into contact with facts and issues relevant to the law or policy at issue. The trainee 12 is typically asked to follow the story by reading or listening to a fact pattern and various principles that are applicable to the fact pattern, then being queried as to what appropriate conduct would be in similar circumstances or on their knowledge of relevant policies, rules and laws. Their answers are evaluated for correctness and the trainee 12 is given remedial information, if any of their answers were incorrect. One training method that may be utilized by the present invention is to show the positive or negative consequences that are experienced by the story's characters that are attributable to certain behavior and decision making. Various other training techniques are available, as shall be described further below.

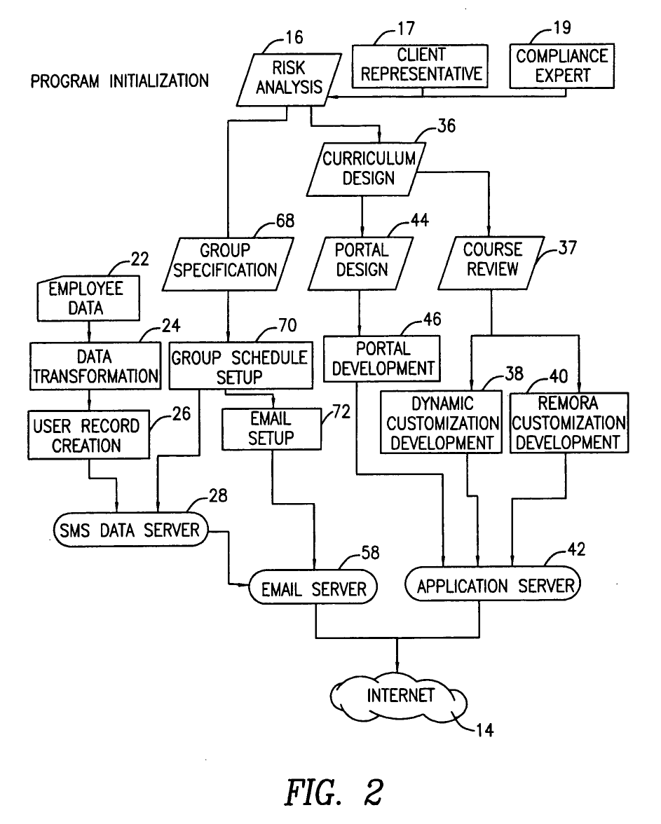

Because different trainees 12 have different duties and functions, their respective interaction with relevant policies, laws and rules will differ and the information, i.e., “do's and don't's” that they need to know may be different. The present invention is cognizant of this fact and includes features designed to provide customized content to specific employees and groups of employees based upon their need to know certain rules to aid them in avoiding negative consequences that would flow from violations of these rules in situations that they are likely to encounter. In the present invention, course content is dynamically configured based upon the trainee 12 or groups of trainees that take the course. It should be understood that the present invention may be utilized to present multiple topics to a person or group of persons over the extended period. For example, a company may need to educate various personnel on various topics, such as Sexual Harassment, Antitrust, Intellectual Property and appropriate Internet Use. Accordingly, the system 10 can assemble and present these various topics, each tailored to the trainees that receive them, over a period of time which will give the trainees opportunity to take the courses without unduly interfering in their other duties. For present purposes, groupings of lessons on the same basic topic will be referred to as a “course” and a set of courses will be considered a “curriculum.” As shown in FIGS. 1 and 2, the process utilized to develop and present employee-specific, risk-based, customized courses, curricula and related communications begins with the process of ethics and compliance risk analysis 16, wherein a client representative 17 knowledgeable about the functions and environment of a particular individual or class of individual trainees 12 confers with a compliance expert 19 employed by the provider, i.e., the owner of the system 10, who is knowledgeable about the policies, principles, rules or laws on which the trainees 12 curriculum will be based. Based upon information received about the attributes and activities of the trainees 12 to whom the course will be given, the compliance expert 19 then selects course curricula (made up of course components, i.e., text, audio and/or image data that can be used to create an orderly exposition of the relevant topic, e.g., in the form of a story (exemplary fact pattern) along with pertinent side notes, quiz questions, amplifying or related information, testing, etc) that is pertinent to the individual or class of trainees 12. The compliance expert 19 typically has a standard course content 32 to draw from which functions as a resource pool from which content can be selected. New content may need to be developed and incorporated into a course to satisfy a need for training that was not previously encountered, e.g., to include a law operative in a jurisdiction that was not previously encountered or a rule promulgated pursuant to the company policy of the client. These components in the nature of blocks of text, images and audio would be in the form of digital data, i.e., computer readable files that can be stored for later recall based upon data linking keyed to, e.g., trainee 12 or trainee group identification, by a server computer 42, and presented to the specific trainee 12 via the Internet 14.

The concept behind ethics and compliance risk analysis 16 is to identify those individual trainees 12 who present a heightened risk of violating a particular rule, law, regulation, code of conduct or policy and provide them with the specific information (training and communications) that will reduce the risk of them doing so. Factors which are frequently considered in such risk analysis 16 include the nature of the industry, the company's business activities, company history, countries of distribution and operation, sales/distribution methods, employees' levels of discretionary authority, the company's organizational and functional divisions, and the targeted employees' job functions and responsibilities. Since numerous individual trainees 12 may have the same general duties and therefore share the same risk factors (e.g., all sales reps of a specific company operating in a specific country, selling the same products, using the same methods) trainees 12 can be grouped for purposes of providing them with relevant course information and communications. Accordingly, the system 10 includes the step of Group Selection 20, viz., the ascertainment of groups of trainees 12 who have a similar risk profile and associated curriculum needs. To make these judgments, the compliance expert 19 (or others employed by the provider) needs to obtain employee data 22 which identifies the employees/trainees 12 and provides additional demographic data, such as their functional or organizational department, job title, job grade or level, region or location, etc. The methodology for obtaining and using the employee data 22 is illustrated in FIG. 2, viz., a client's employee data 22 (name, ID number, company, email address, job title, department, etc.) is put into digital form, e.g., a spreadsheet, and then transmitted to a filter program for Data Transformation 24 using a library of customizable TSQL Cursors and TSQL DML (data manipulation language) which conducts a data transformation to create user records 26 in a format suitable for loading into a Microsoft SQL-Server relational database 18 available to the SMS (Subscription Management System) server 28. As shall be explained further below, the SMS server 28 is used to communicate with trainees 12 through email communications to induce the trainees 12 to visit the website where courses are presented by the application server 42, to identify themselves (“log-in” or enroll), receive and participate in the course, and (via completion of all lessons and elements), successfully complete a final test, and receive notification of completion.

Still referring to FIGS. 1 and 2, the process of risk analysis 16 leads the compliance expert 19 (and others employed by the provider and acting at the direction of the compliance expert 19), in conjunction with the client representative 17, to select/prepare Custom Content 30, generating the actual course components (blocks of text, images, sound files, etc., i.e., Standard Course Content 32, Remora Course 40 and/or Dynamic Customization 38 (as generated by the processes of Dynamic Customization Development 38 and Remora Customization Development 40, respectively, which are described more fully below. As can be appreciated from FIG. 2, risk analysis 16 includes curriculum design 36, which is the selection of a risk-based curriculum of interactive courses for each trainee group. For example, the sales executive group for a pharmaceutical company might receive an initial curriculum including the courses, “The PhRMA Code on Interactions with Healthcare Professionals, “E-compliance—the dangers of email” and “Pharmaceutical Sales and Marketing—Laws and Regulations”. The system 10 therefore provides the presentation of a customized set of courses with custom content targeted to the specific trainee 12 and their specific risk profile and continues a group-specific curriculum and related communications on an ongoing basis.

As noted above, the Courses to be included in the curriculum are reviewed 37 by the client 17 and the compliance expert 19, to determine necessary content customization. For each course, a determination is made as to whether the customization will be accomplished during Dynamic Customization Development 38 and/or Remora Customization Development 40. This decision is based upon the amount and location of the necessary customization.

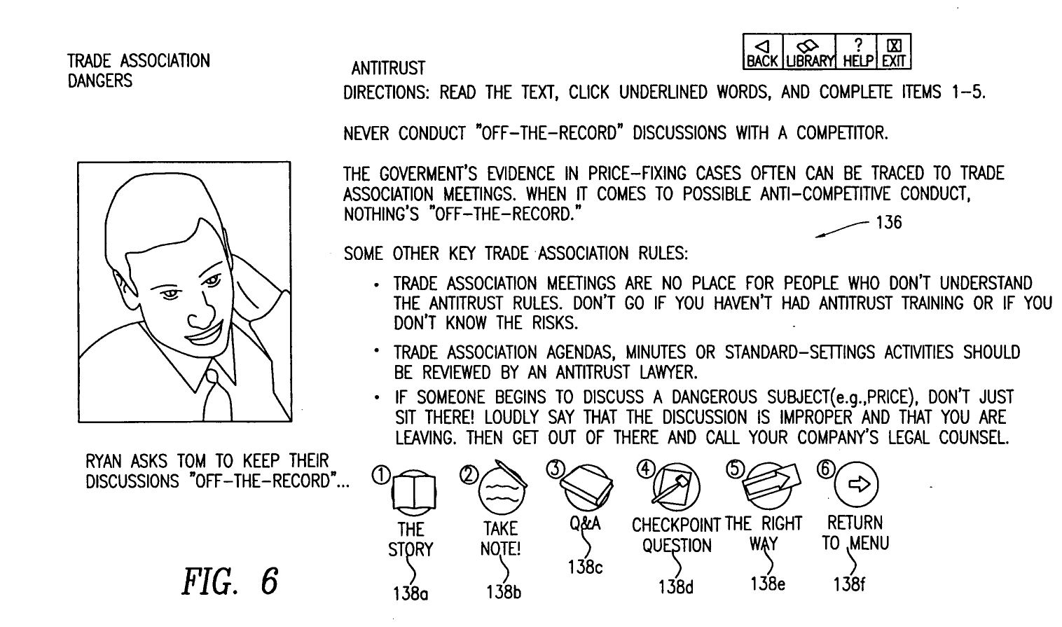

Dynamic Customization 38 is delivered to a trainee 12 by JavaScript programs during the trainee's use of the system 10 when they are taking the course. More particularly, the Standard Course Content 32, the Dynamic Customization 38 and/or the Remora Course 40 are stored on data server disk 33 accessible to Application Server 42. When the trainee 12 signs-on to the Application Server 42 through the Internet 14, and identifies himself, the system 10 automatically retrieves all content components 32, 38 and 40 targeted to that specific individual as they take the course. This type of data association is available through use of relational databases wherein data is stored in table form with linked fields. The trainee 12 is unaware of which parts of the course are common to the courses shown to others and which parts are customized for them or their risk group. Dynamic Customization 38 can be associated with/accessed by “buttons” or “links” displayed during course presentation. As shall be described below, these links, e.g. Take Note 138b or Q&A 138c, (see FIG. 6), are used to divide course content into logical, functional, modular components which are accessed under the trainee's initiative. In this manner, the trainee 12 participates in the training provided, which makes the course more interesting and gives the trainee 12 a degree of control over the order and timing of material presentation. (As shall be explained, however, the system 10 guides the trainee 12 in reviewing all of the course content and requires comprehensive review prior to course completion.) When a user clicks on a button such as Take Note 138b, or Q&A 138c, a JavaScript program uses the employee's individual or group identification designator to access the appropriate Dynamic Customization 38, i.e., text, audio and image files stored on the data server 33. This information is retrieved, formatted and displayed to the trainee 12 in a pop-up window within the course. To maintain an audit trail of the information delivered, a JavaScript program records what custom information was displayed to each trainee 12 in a tracking table in the SMS database 18.

Remora Customization Development 40 allows changes in course content not amenable to Dynamic Customization Development 38 and involves creating a new derivative (Remora) course that is a copy of a preexisting (host) course and is then revised. Remora Customization Development 40 maintains separate customized pieces of a course that draw unchanged content from a host course. To create a Remora course, a new course identifier is established and a directory is established on the Application Server 42. This process is explained in greater detail below, but in general, the core lesson ASP page for each course lesson is copied from the host course directory and modified with the new course identifier. (This can be done by a single developer in as little as 15 minutes.) The course pages that require customization, i.e., by editing, adding and/or deleting content are also placed in the Remora directory. All unchanged content continues to be automatically referenced in the host course by the Remora course. The Remora Development 40 implies that updates to the parent course are automatically shared by all Remora versions because each Remora course refers to file data in common with the host course. The Remora system reduces cost and development time and it also offers reduced QA time, saves disk space, improves performance due to better cache usage, and reduces cost and increases accuracy of course updates. Having developed Course Content 32, Dynamic Customization Data 38 and Remora Course 40, all data components are transmitted to data server 33 for use by the application server 42 to present courses to trainees 12 over the Internet 14.

The client representative 17 also cooperates with the compliance expert 19 (and others employed by the provider and acting at the direction of the compliance expert 19) in Custom Portal Design 44. During Portal Development 46, a Custom Portal 34 for presentation to the trainee 12 is assembled from text, images and audio data. As shall be described more fully below, the Custom Portal 34 may be utilized to project sponsorship/approval of the course by the trainee's employer and otherwise convey the context in which the course is presented.

The system 10 of the present invention includes a Subscription Management System (SMS) 48 having a plurality of programmatic “agents” that administer, monitor, and manage the delivery of training. The SMS 48 is written in the JavaScript language to run on SMS server 28 (Microsoft Windows 2000 server) linked to a database management system (SQL 2000) for retrieving data from database 18. To ensure security of client data, SMS server 28 access requires password authentication on Microsoft LDAP server, and a two-factor security token. The SMS server 28 and database 18 are preferably located in a secure facility with biometric access and reside on a separate network from the application server 42. The SMS 48 employs automated agents that execute database procedures at predetermined intervals, e.g., an Enrollment Agent 50, a Reminder Agent 52 and a Completion Agent 54.

As shown in FIG. 2, Risk Analysis 16 includes Group Specification 68 wherein employee data 22 is analyzed to determine if employees (trainees 12) can be divided up into groups to whom common training can be provided. The objective would be to produce the minimum number of custom courses possible while still providing appropriate risk-based training to all trainees 12. In addition to dividing trainees into groups for whom custom courses are developed, the client representative 17 and compliance expert 19 develop a Group Schedule Setup 70, which determines the timing of presentation of curriculum/courses to trainees 12. The scheduling goals determined by Group Schedule Setup 70 are utilized in Email Setup 72 which schedules emails having a predetermined Email Content 74 to be sent to trainees 12 by the Enrollment Agent 50, Reminder Agent 52, and Completion agent 54. The Email Queue 62i and email content 62h are placed in the SMS database 18 which is searched by the aforementioned agents 50, 52, 54 for data indicating an email should be sent. Emails are placed in the Email Queue 62i for delivery by the Email Server 58 to the Internet 14 and the recipient trainee 12. More specifically, the Enrollment Agent 50 determines when a trainee 12 should be enrolled in a course. This is primarily determined by analyzing their group curriculum, their individual completion history, and the group schedule, information stored in tables 62a-i in the SMS database 18. The Enrollment Agent 50 can accelerate a curriculum (to meet the client company's annual training objectives), modify a curriculum (to insert an unplanned course to meet unexpected ethics or compliance training needs), or delay a curriculum (e.g., if the trainee 12 is on leave). When the Enrollment Agent 50 determines that a new enrollment is appropriate, it: inserts a new subscription record; updates the user record; and places an appropriate “Welcome” Email (to invite enrollment) on the Email Queue 62i for processing by the E-mail server 58.

The Reminder Agent 52 monitors whether a user has completed a course in the time frame specified in the group curriculum. If not, then after the specified number of days, the Reminder Agent 52 places a reminder email request on the Email Queue 62i. Various different reminder emails may be specified for each group and course combination. The Completion Agent 54 monitors the completion of courses by trainees 12. When a course is completed, the Completion Agent 54 queues a completion e-mail in the Email Queue 62i, updates the User Table 62a to avoid further reminder e-mails and to allow new enrollments. Several times a day, one of the automated Agents 50, 52, 54 processes a series of queries to database 18 to locate trainees 12 who require welcome, reminder or congratulations/completions emails. Determining if an email is required, as well as which type is appropriate, is based upon the date of the last email sent to the person, the completion status, and the number of days or date value specified in the relevant risk-curriculum/course email program. The required emails are then placed in the Email Queue 56 for emailing. To avoid errors, a human account manager may review queued emails and release them for sending.

The e-mail processing capabilities of the system 10 allows large numbers of customized emails to be sent at the appropriate time to trainees 12 with different risk profiles, taking different courses and curricula, and reflecting individual company requirements as to content, timing, etc. The system 10 also provides facilities to carefully schedule emails based on a “number of days between emails,” “specific date” or even on a “later of the two” basis. This is important because companies often want to slow or accelerate training based upon factors such as busy times of the year or other training initiatives. The emails are assembled dynamically from coded text strings stored in the database 18. This allows the emails to be individualized by sender, subject, body, copy recipient, and signature area. Each group/course will have at least the following customized emails: Welcome, 3-6 Reminders, and Congratulations (completion). When an email is sent to a trainee 12, a record is made in the database 18 of the date along with a unique email code to allow the exact text of the email to be recreated at a later date.

Curriculum Design 36 designates the courses to be taken based on company, group or individual risk, the order of courses, and the timing of courses, each of which are implemented by the SMS 48. The order and timing of courses is important because certain courses have a higher priority for some client companies. In addition, some client companies prefer a regular program that does not cause undue interference with employees' job functions. Typically companies wish to provide 3-6 courses annually with at least 30 days between courses. The SMS 48 supports this “intensity”, as well as meeting special needs for very fast rollout, such as providing 3 courses as soon as possible or rollout based upon fixed dates, instead of courses available over a block of time.

The data corresponding to a curriculum of courses, i.e., that identify the courses to be taken by a specific trainee 12 or group of trainees 12 and the associated schedule is stored in a curriculum table 62d in database 18. The curriculum table 62d may be modified to alter the curriculum or related email communications before or during the training process. As noted, a curriculum contains one or more courses, specifies the order of courses, a rollout date and/or a minimum number of days to elapse from completion of a previous course, and a time period between related Welcome and Reminder emails. The SMS 48 provides two modes for training a group, viz., Cohort and Continuous. In Cohort mode, a group of trainees 12 are moved through a curriculum at approximately the same rate, with everyone taking the same course at the same time. In the more common, Continuous mode, each employee is moved through the system with a “Number of Days” gap between courses and employees in the same group are participating in different courses of the group curriculum at any given time. The continuous mode allows new or transferred employees (trainees 12) to start the appropriate group curriculum at any time.

As shown in FIG. 1, the process of enrollment 76 wherein a trainee 12 signs-on, connects to the Application Server 42 and selects a course, may be followed by the selection of optional courses 78. The Optional Course Facility (OCF) 78 allows trainees 12 to take courses that are not part of their group curriculum. This is accomplished through the SMS 48 optional course facility 78 and optional course logic accessible in the Custom Portal 34. When a trainee 12 selects an Optional Course in the Custom Portal 34, a Javascript program accesses an optional course table in database 18 and then dynamically creates and displays a list of optional courses made available to that specific trainee 12 based upon their risk group. The trainee 12 can then start a course by clicking on any course name in the optional course list. This action will cause a JavaScript program to instantaneously enroll the user in the course and initiate the course. The SMS 48 permits contents and display order of the Optional Course List to be modified. Consistent with the approach of providing customized content to specific trainees 12, different optional course lists can be provided to each trainee 12 or of trainees 12 group to present relevant and/or appropriate courses. The SMS 48 enrollment system is a JavaScript program that enrolls an individual in their next course. As mentioned before, the SMS 48 may be used to promote an “ongoing” training model where trainees 12 take a number of courses spread over time. Instead of showing trainees 12 an entire list of courses that they are required to take, the SMS 48 shows a trainee 12 only one required course at a time, but also may provide the option of taking a list of optional courses.

A Testing Tracking System 80 administers tests to trainees 12, scores the tests, reports the results to the trainees 12 and drives the trainee through a remedial lesson(s) and testing on the incorrect answers. These processes are implemented in the system 10 by the following features: Test to 100% 82, Anti-Click Through 84 and Test Randomizer 86. It is generally desirable that trainees taking ethics and compliance courses receive a 100% score on test questions, indicating a thorough review of and comprehension of the course. A record that a trainee 12 took and successfully passed a compliance course can have a legal effect, e.g., by showing that the sponsoring client company expended reasonable effort to inform its employees about the operative policies, rules and laws in the relevant area. This legal effect is maximized if “passing” means obtaining a perfect score, through remediation if necessary. Other testing methods that allow course completion without driving the trainee to achieve a perfect score allow for gaps in comprehension of the training content. The system 10 of the present invention provides a process to facilitate obtaining a perfect score, viz., after taking a test on the subject matter of a course, the trainee 12 is presented with review material on any missed questions. The test is then repeated, but only the questions missed are presented to the trainee 12. The remedial questions are on the same subjects, but the multiple choice answers are randomized and no indication is made of which answer was given before. The trainee 12 typically repeats the test with fewer and fewer questions until all questions are answered correctly. This is a rigorous approach, in that it forces the trainee 12 to demonstrate full comprehension of the training content, but allows virtually all test takers to ultimately achieve the 100% score upon diligent participation. No permanent record is made of the partially incorrect tests scores.

The Anti-Click Through 84 feature of the Testing Tracking System 80 is another means to assure thorough review and comprehension of course content, that is, by preventing a trainee 12 from “clicking through” a course without reviewing and considering course content. The Anti-Click Through 84 maintains a timer on each lesson. If a trainee 12 completes a lesson more quickly than could reasonably be done, they are given a pop-up message that asks them to slow down and participate more carefully. The Anti-Click Through 84 is designed so that it is not obvious what method is being used to evaluate the pace of course completion. In practice, trainee 12 could readily conclude that there is something more sophisticated than a timer. Course completion and testing results are recorded by Course Tracking 88 for long term storage and for reporting to relevant persons, such as an employer of the trainee 12.

FIGS. 1 and 2 show a system 10 for providing effective corporate ethics and compliance training over the Internet 14, which includes: a) One or more Database server computers 28 containing a database management computer program such as Microsoft SQL 2000 and database tables, e.g., 62a, of information used in the system. These tables comprise the system's SMS database 18; b) One or more Application Server computers 42 connected to a Database server 33 and having access to the data tables in the SMS database 18 and a network, such as the Internet 14 and having access to the data in the SMS database 18; and containing computer files of content for the training and files of computer programs to enable the delivery of the training content files to users; c) one or more Email Server computers 58 connected to the database server 18 and the internet 14 configured to transmit customized electronic mail to users over the Internet and having access to the data tables in the SMS database 18; and d) one or more Reporting Server computers 43 connected to the SMS database server 18 and to the Internet 14 configured to create and transmit various reports and analysis of the information in the SMS database tables, e.g. 62a.

The system is primarily used to deliver one or more customized ethics and compliance courses in topics such as Antitrust, Code of Conduct, Insider Trading, Intellectual Property, and Export Controls to one or more employees of a company. When a course is created it is assigned a course code by the developer in the form IP03STDfr where the first two characters indicate the overall topic (in the example Intellectual Property, the third and fourth character indicate a version of the course, characters 5-7 indicate an assigned Company Code (such as KRF for Kraft) and where a company code of “STD” for standard indicate the course is for use by more than one company. Characters 8 and 9 are optional and indicate that the course is in a language other than English. In our example “fr” indicates the course is in the French language. All courses must be indicated by a course code but the system supports the use of alternate course code systems.

Each course consists of Course Content files stored in disk directories on an Application server 42. The files are of one or more common web file formats such as “html” or “asp”. Contained within these web pages is text, formatting commands, java script program statements, XML program statements and other standard web page components. The Content files may also include files containing graphics, audio, video, or other media types. The system supports all standard web file formats and programming language and can be extended to future formats as they are developed. The files are delivered over the Internet 14 to a User as the User views the course. Most of the courses currently used in the system 10 have been developed by the provider and utilize all components of the system. The system 10 does support courses developed by other developers that use similar standard web course technology. Courses developed by other developers use a subset of the system (Dynamic Customization 38, Remora Customization 40, Test-to-100% 82, and Anti-click Through 84 are only supported in courses developed by the provider).

The provider's course design utilizes a variety of commonly used web training course designs, methods and technologies including interactive stories, multiple choice questions, static text, dynamic text, audio and video segments, user tests, topic menus, static graphics, animated graphics, question and answer sections, incorrect and correct behavior examples, control panels, and interactive buttons. There is no requirement in the system 10 that all of these methods be used or that they be used in the same way from course to course.

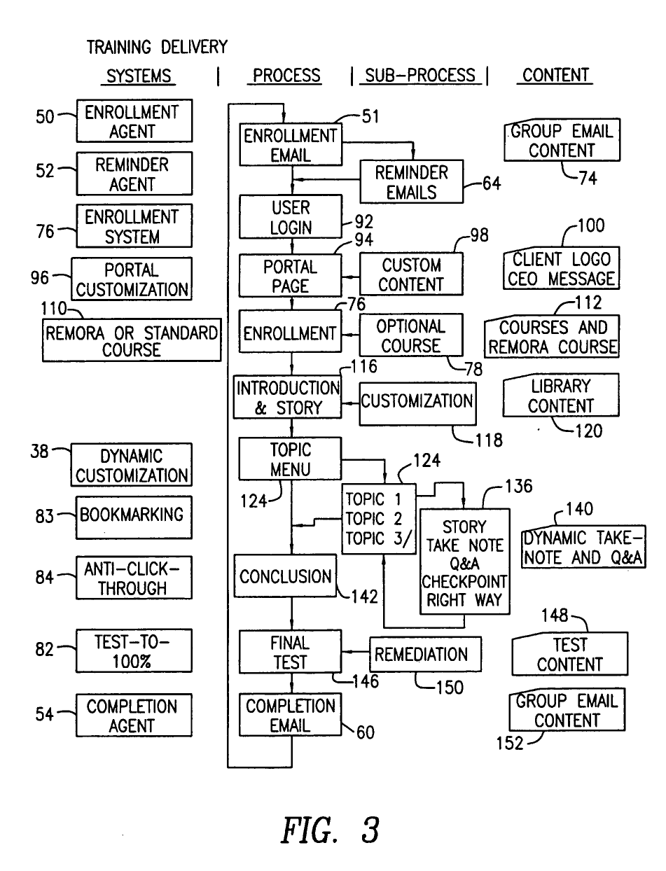

A course developed by the provider usually consists of between four and six Topics 124 (see FIG. 3) where a Topic is a single ethics and compliance concept, for example in the Antitrust course, there is a topic on “Price Discussions”. An example of a course developed by the provider consists of an introductory page that introduces the user to the course, two story pages where the user begins to an interactive audio story, a Topic Menu page that displays the titles of the four and six Topics in the Course, the Topic pages, five standard required topic elements 138a-138f (the story, take note, Q&A, Checkpoint questions, Right way) for each topic, a conclusion page, and a final test module. The course also includes a Library section that contains pages with additional information including a glossary, course abstract, complete Q&A text, company policy documents and other information that may be viewed or printed by user. The system 10 does not require that a courses use the design described but other designs may only be able to utilize a subset of the features and capabilities of the system.

The system may be used to deliver courses in hundreds of compliance and ethics topics and additional topics may be added as needed. It is obviously inefficient for an employee to take all, or even most, of these topics as many of them are not relevant to a single employee. For example, an employee in an automobile factory is unlikely to need knowledge about antitrust law. The most effective ethics and compliance training is believed to be achieved when an employee takes courses that most appropriate for them due to the compliance and ethics risks they present. The system includes a method to develop one or more Risk-based curriculums that consist of an ordered set of courses designed for an individual with certain risks. For example, the risk based curriculum for “sales executives” might first require them to take a course in antitrust law, next a course on conflicts of interest, next a course on anti-harassment, and so on. On the other hand, the Risk-based curriculum for a “graphic artist” who works in the marketing department might begin with a course in intellectual property protection. Each Risk-based curriculum provides different customized training to a specific group of employees who share common compliance or ethics risk factors such as job location, industry type, company characteristics, job function, job seniority, governmental investigations, and international business.

The Risk-based curriculum method has several components. As noted above, a risk analysis 16 is performed by one or more individuals with expertise in ethics and compliance and a knowledge of the company to identify the relevant ethics and compliance risks presented by the company's employees. The experts in ethics and compliance identify one or more groups 20 of employees who share similar characteristics based upon risk characteristics such as job function, location, and seniority. The experts next determine the courses that would best mitigate the compliance and ethics risks presented by these groups. For a given group, the identified courses are organized into one or more Risk-based curriculums. Each employee group is then assigned a Group Code. A typical company might have six groups such as “Sales”, “Finance”, “Senior Managers”, International”, “Marketing”, and “Other” assigned Group Codes “S”, “F”, “SM”, “I”, “MK”, “O”. The system supports any number of groups and group codes of any length consisting of any combination of letters or number.

Each company to which training is to be provided is assigned by provider a unique three letter company code in a form such as “KFR” for Kraft Foods. Any combination of letters and numbers may be used in the Company Code. The Company Code is used throughout the system to associate information with a company's employees.

Prior to the start of training, the company transmits to the provider information 22 about the employees who are to receive training. This information may be either in electronic or written form and typically contains the employees' names, email addresses, location, job title, job grade, and department. Multiple pieces of information, e.g., ten, may be transmitted about each employee. The specific pieces of information are selected by the characteristics of the company and the training to be conducted so as to be sufficient to determine each employee's group. For example, a value of “Sales Executive” in the Job Title field can be used by provider to designate the employee as a member of Group “S” which in turn is a group to receive the “Sales” risk-based curriculum. The provider uses a series of database programs to transform 24 the data into a format suitable for the SMS database tables. The data is then added to SMS database 18 User table and the Group field in the User table is updated with each employee's chosen Group code. A unique User ID is also generated by a computer program containing the employees Company Code appended to an alphanumeric string of up to 20 characters. An example of a User ID is “KFT3215”. The User ID for each employee is used to update the User ID field of the SMS database. During the training, the company typically transmits updated information about new employees, terminated employees, and changes in employee information 22. This data is used to update the database. In addition the company transmits ethics and compliance information in electronic, written or other form to provider to be included in the training course(s). This might include written documents, management audio messages, and corporate graphics. Provider converts such information into suitable computer files for use in the Customization section 81 of the system 10.

It is believed that the most effective ethics and compliance training is customized to reflect the risks associated with each employee's company characteristics, their job function, location, and similar risk factor characteristics. The system's Customization System 81 is able to deliver a highly individualized training to each user. This can include customization as to which courses they take (as described in their group's risk-based curriculum), customized for their job function, customization for their company, and customization for their industry. For example, consider a pharmaceutical sales executive named Sue who works for a fictional pharmaceutical company called “Major Pharmaceutical Company”. Sue's sales territory is in the United States. Sue presents substantial ethics and compliance risks due to the nature of her job. The Risk-based curriculum system has been assigned a Company Code to Sue's company of “MPC”. The compliance expert created a Group 3 for US sales executives and assigned a risk based curriculum that begins with a course in Pharmaceutical “conflicts of interest”. This course was selected by the compliance expert 19 because improper gifts to physicians by pharmaceutical sales executives has in the past created illegal conflicts of interest which have been a serious problem to pharmaceutical company's such as MPC.

The system's Customization system 81 is designed to deliver to Sue a course about conflicts of interest that contains custom industry information about gift rules in pharmaceutical industry, as, for example, specified by the pharmaceutical trade group PhRMA, custom company information about MPC's specific policy prohibition against golf outings with doctors, and custom location information about the specific documentation rules for drug samples in the United States. The items in the course Library are also customized. This customization is accomplished by several different components of the customization system.

To access the training, a user 12 enters a web address (URL) that they receive in the form of, for example, http://www.integrityweb.net. This Internet address when entered into the user's browser displays a “Login” web page generated by the enrollment system. The user enters their individual User ID into the login system and the enrollment system locates the user's subscriber record in the SMS database User Table 62a and obtains the Company Code, Group Code, Portal page name, and current Course Code for that User ID. The information so obtained is copied to a temporary memory variable associated with the user's Internet session for use by the customization system 81.

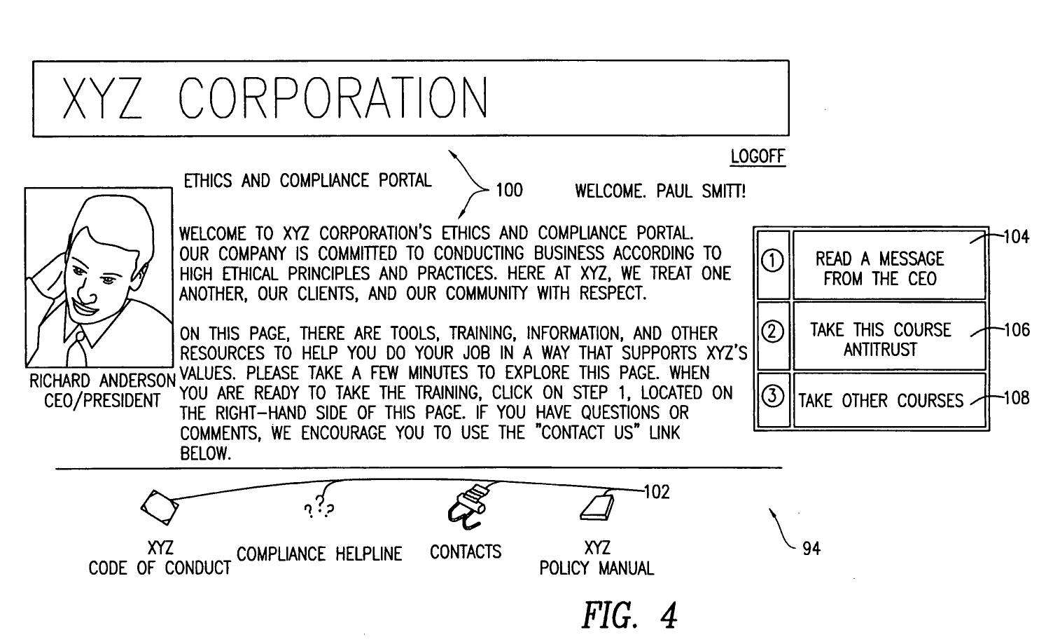

The Customization system 81 next uses the Portal Page Name, Company Code, Course Code, Group Code, and User ID to create and display an ethics and compliance Portal page 94 (see FIGS. 3 and 4) for the user. Each company has one or more Portal pages stored as files on the Application Server 42. A typical Portal page would include a message from the company president in audio and text, the company graphic logo and links to several company compliance policies. The name of this file is stored in the SMS database user table 62a and is displayed after the user has completed Login. The Portal page 94 also includes an area to display the name of the course the user is to take. To display the correct course name, the customization system accesses the Course Information table 62b in SMS to obtain the English (or other language) name associated with the Course Code stored in the user's Users table 62a record. For example, if the user was assigned the Course Code IP03STD the Customization system 81 would obtain the title “Intellectual Property” associated with course code IP03STD from the Course Information table and display the text on the portal page in a box marked “Take this course”. The course title is programmed with a standard HTML link. Clicking on the link would execute the enrollment system so as to start the IP03STD course.

Also displayed on the portal page 94 is a link 108 to Optional Courses. This section of the enrollment system provides a facility for the user to take other appropriate courses. If the user clicks on the Optional Course link 108, the Optional Course system uses the Company Code and Group Code for that user to obtain a list of approved optional course codes and titles for that group from the SMS Database Optional Course table. It is rarely appropriate to offer all courses to a user. For example, a factory worker in the defense industry would not have a pharmaceutical industry sales course made available to them in the optional course list. Each group in each company may be is assigned a different optional course list. These optional course lists may be modified at any time by using the SMS Administrator Program 55 (see FIG. 1) to modify the Optional Course table in the SMS database 18 (another table as indicated by the ellipsis . . . ).

When the user begins a course, the Course Code is used to select the file “start.htm” file in a particular disk directory on an application server 42 corresponding to the Course Code. In the example, the course code IP03STD would access a directory/IP03STD. As noted before, the letters “STD” in this course code indicates that the course is a “standard course” which is used by more than one company. Standard courses may be customized using Dynamic Customization 38. This real-time form is implemented when a user clicks on a button or link within the course that contains JavaScript program code to access the Dynamic Customization system. For example, if a user in company MPC group 3 clicks on a button marked “Q&A” in lesson 3 of the IP03STD course, it executes the attached JavaScript program to perform dynamic customization. The JavaScript program will access the SMS database Course table 62b to locate the correct dynamic customization file name for the specific course, company, group, topic, and item values. This file is then immediately displayed to the user. Dynamic Customization 38 permits a sales person in Canada to receive different Q&A information than a salesperson in California or a marketing person in Canada. This information can be easily modified by changing the contents of the Dynamic Customization files and the contents of the SMS course database tables. Although any number and any sections of a course may be configured for Dynamic Customization, it is commonly applied by provider to two to three items in each course Topic page 136 (see FIG. 6) such as “Take Note”, “Q&A”, and “Policy” as well as the Library: Dynamic Customization files usually contain html text but can also contain any of the web technologies used in the course and can in turn refer to other graphic or audio/video files.

Sometimes a user requires customization that is not suited to Dynamic Customization. This usually occurs when the content changes are numerous or require changes to the teaching text. In this case a “Remora” Course 40 is created. Remora courses are assigned a Course Code that contains the Company Code. In the previous example, IP03STD is the standard course; IP03MPC would be a Remora course designation for the “Major Pharmaceutical Company” which was assigned company code “MPC”. A directory is established on the Application server 42 named IP03MPC and this directory contains those content files that are different in content from the files in IP03STD. Remora file directories typically contain a smaller number of files. While the directory for the standard course (IP03STD in our example) might contain 200 files comprising the entire course, the directory for the Remora custom course (IP03MPC in our example) might contain only 15 files where those 15 files contain (a) the content differences from IP03STD and (b) those files that contained links to the modified files of (a). To create a Remora course, a developer creates a copy of a subset of the standard files to be modified for the Remora course. They then modify the content of these files as needed with the custom content information and assign a modified file name. The developer then make a copy of those files with links to the modified file into the Remora directory and modify the links to reflect the new file name. All other links continue to refer to the original files in the standard course directory. When the User 12 views a Remora course the customization system automatically uses the files from the associated standard course directory for all files not located in the Remora course directory. The advantages of the Remora system are that it permits any part of a course to be customized without duplicating the work required to create a standard course. An experienced developer can create a Remora course in approximately one hour compared with an average of 40 hours for a standard course. The Remora course also reduces the time required for quality assurance from six hours for a standard course to less than one hour for a Remora course as only the modified sections of the course based on the subset files in the Remora course directory need to be verified. The Remora course also reduces ongoing maintenance costs because a change in a content file in the standard course directory will be immediately be reflected in all associated Remora courses that do not have a custom file for the updated file in the standard course.

It is believed that more effective ethics and compliance training is achieved when the company can demonstrate that the trained employees have viewed all required components of the courses assigned to them and they demonstrated their comprehension of the content by correctly answering all questions in a test (that is “test to 100%).

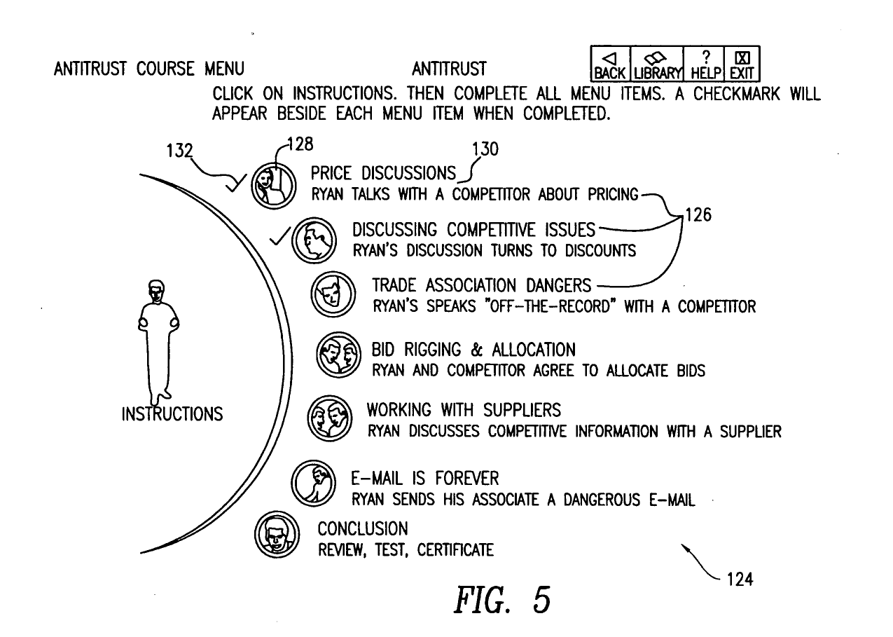

The decision as to which courses and topics a user should view is determined by a compliance expert 19 during the risk-based curriculum definition. The system does not permit “self-assessment” where an employee chooses the course or sections of a course they view. The nature of compliance training is such that many employees are not aware of the compliance risks they present. For example, many salespeople would not know that Antitrust law applied to their activities as salespeople. The system requires users to complete all required elements of all topics contained in the courses contained in the user's risk-based curriculum. To assure that users complete all required pages, the tracking/testing system 80 utilizes bookmarking 83, i.e., maintains bookmarks in the form of a session variable array of data flags for each required page. The bookmark array value (or flag) associated with the particular page is set to true by a JavaScript program when a user clicks on a link to display the page. After the user views the page associated with the link and returns to the previous page, another JavaScript program is executed to cause a graphic of a checkmark 132 (see FIG. 5) to be displayed in the proximity of the previously activated link 126 reflecting that the bookmark array variable for that page is now set to “true”. Each required page link in the course contains a similar pair of JavaScript programs, one to set the bookmark and one to display a checkmark if the bookmark is set.

The bookmark array is used to guide the user through the required course pages. When a user attempts to exit a course topic or the course, the exit button executes a JavaScript program that inspects all bookmark array elements associated with the topic or course. If any required elements are not set, a warning box is displayed to the user to notify them that they have not viewed all required content. The system also generates a list in the warning box of the specific pages that do not have flags set and therefore have not been viewed by user 12.

While the bookmark array is maintained as a memory variable array while the user takes a course, the information is also stored in the SMS database 18 table Activity (another table in the SMS database 18 shown by ellipsis) so that the information is not lost on course exit. When a user clicks on any exit button or “return to menu” button in a course, an javascript program associated with the button converts the bookmark array variables flags into a single text string value in the form “11, 13” Where “11” indicates that the user has viewed page 1 of topic 1 and page 3 of topic 1. The text string is then copied to the SMS database table “Activity” in a record associated with current User ID and Course ID. If the user returns to a course that they have started but not finished, the enrollment system accesses the correct record in the SMS database table “Activity” and copies the bookmarking string value to the bookmarking memory array elements. This causes the checkmarks to be displayed for those pages of the course that the user had previously viewed.

The bookmarking system 83 is used to evaluate when a user may take the final test component of the course. A JavaScript program is associated with a link 126 marked “Conclusion and Final Test” on the course menu page 124. This java script program enables the link to the final sections of the course only when all bookmarks associated with all topic areas have been flagged. This means that a user may not take the final test until they have viewed all required content pages.

The anti-click-through system 84 prevents the user 12 from spending insufficient time in a course. In the anti-click through system 84 a computer program evaluates the amount of time that a user 12 spends viewing each topic in the course. If the viewing time for the topic is less than a predetermined amount of time, a warning message is displayed directing the employee to spend additional time. This message is displayed even if all bookmarks have been set for the topic. The anti-click-through system 84 prevents the bookmarking system 83 from setting the topic bookmark flag until the anti-click-through time value has been reached.

The final test utilizes the “test-to-100%” system 82. To meet the effectiveness standards of ethics and compliance training it is important that users answer all test questions correctly. The Test-to-100% 82 accomplishes this goal in a manner that is superior to other practices. The test consists of a series of web pages each of which contains a single multiple choice question. A user clicks on their preferred answer for a question and advances to the next question. When all questions have been answered, a JavaScript program determines how many questions were incorrectly answered and a “summary” page is displayed. This page lists which questions the user answered correctly and which questions they answered incorrectly. A button is also displayed beside each question that contains a link to a page with remedial training information associated with the particular question. If a user has answered any questions incorrectly, they are asked to click on a button to repeat the test. The “Test-to 100%” system 82 then repeats the test but in a manner so as to exclude during the repeated test any question(s) that the user has previously answered correctly. For example, a user takes a test of eight multiple choice questions during which the user answers question number 3 and question number 5 incorrectly. They then retake the test but only have to answer questions 3 and 5. If the user then answers question 3 correctly but answers question 5 incorrectly again they will be asked to take the test a third time in which event the “test-to-100%” system 82 will only present question 5. This process continues until all questions have been answered correctly. The system does not record any score information in the SMS database. When all questions are answered correctly the testing system creates a new completion record in the SMS database History table that contains the User ID, the Course ID, the current date and the code letter “C” indicating the course has been completed.

The testing/tracking system 80 contains a test question randomization system 86 where a computer program randomly reorders the display of the answers to each multiple choice question in a test to prevent employees from providing a list of correct answers to other employees who later take the same training course. To provide a consistent evaluation of training comprehension all users receive the same questions and are offered the same multiple choice answers, but the randomization system reorders the answers. For example, for one employee, the correct answer to question 3 is answer “A”, for the next user the correct answer to question 3 is “C”. The computer program also randomizes the answers when questions are repeated by the test-to 100% system 82.

The SMS system 48 consists of data tables, computer programs written in JavaScript, web pages containing ASP program statements, and SQL database queries. The SMS system 48 uses these components to create computer agents, e.g., 50,52,54,57 and an administration system 55 to intelligently manage and send customized emails to employees to facilitate the efficient and timely completion of the risk-based ethics and compliance curriculum. The SMS system 48 is believed to achieve higher completion rates of training than other methods.

The SMS database table includes the Curriculum table 62d. This table contains records that describe the risk-based curriculum. Each curriculum has a curriculum designator including a series of course records. Each course record contains an indicator of its position in the curriculum and schedule information. The schedule information indicates a number of days that should elapse after the user is first entered into the system or after the previous course completion. The schedule information also includes an optional value indicating a calendar date before which the course may not start. Each course also is associated with a table Course Emails 62g that contains an ordered list of emails to be sent. This includes a “Welcome Email”, up to six “Reminder Emails”, and a “Completion Email” (congratulations). Each email record contains an email designator code in the form AT_MFC3_E1 where AT indicates Antitrust, MFC3 indicates company MFC group 3 and E1 indicates enrollment email version 1. Each email record also contains the email code of the next email in the sequence. Each email record also contains schedule information as in the course record that determines the date that each email is to be sent.

The SMS Enrollment Agent 50 computer program executes at a predetermined frequency to examine the SMS database tables to locate those employees who are to be enrolled in a course. This information is calculated using the information in the risk-based curriculum tables 62d and the information in the User tables 62a. The risk-based curriculum tables 62d contain schedule values that specify a specific date or the number of days after a user's record is entered into the SMS database 18 when they are to be enrolled in the first course indicated in the risk-based curriculum. After they complete the first course, the risk-based curriculum table 62d contains a value for the number of days or a specific date when the user should be enrolled in the second course in their curriculum. This process continues through the entire risk-based curriculum. Courses may be added, removed, or schedule information changed as needed in each risk-based curriculum using the SMS Administrator 55, in which case the updated information is then used by the Enrollment Agent 50 as it processes all future enrollments. When the day is reached when a user is to be enrolled in a course, the Enrollment agent 50 uses a series of database queries to (a) update the User record, (b) create a new record in the SMS Course-User table 62f to store bookmarking information and set a Course Code value to be used by the Portal customization program to display the correct course title for the user's current course. The enrollment agent 50 accesses the risk-based curriculum table 62d to obtain the Email Code for the enrollment email based upon the Company Code, Group Code, and Course Code for the course. This email code is then added to the Email Queue table 62i with the information from the User table (such as the user email address) necessary to construct and transmit the email to the User 12.

The SMS Reminder Agent 52 computer program executes on a predetermined frequency to examine the SMS database tables to locate users where a specified number of days as specified in the curriculum table has elapsed since the last enrollment or reminder email was sent. The scheduling information is stored in the SMS database Curriculum table 62d. The Reminder agent 52 consists of a JavaScript program and a series of stored database queries that selects the appropriate user records and obtains the correct Email code in the same manner as the Enrollment agent 50. This email code is then added to the Email Queue 62i table with the information from the User table 62a (such as the user email address) necessary to construct and transmit the email to the User 12.

The SMS Completion Agent 54 computer program executes on a predetermined frequency to examine the History table 62c to determine users who have recently completed an enrolled course. This is accomplished by executing a javascript program containing a series of stored database queries to locate History table completion records that have been created by the tracking system in the period since the Completion agent 54 last executed. The selected History table records are then marked as processed and a Completion Email Code is determined from the Curriculum table based on the User ID and the Course Code. This email code is then added to the Email Queue table 62i with the information from the User table 62a (such as the user email address) necessary to construct and transmit the email to the User 12.

The SMS Email Agent 57 computer program executes on a predetermined frequency to examine the Email Queue 62i database tables to determine when a particular email should be sent. Each record is examined to determine if the record has been “released” for mailing and if the target date/time for sending has passed. When these conditions are met, a computer program is executed that assembles the email using information in the email queue record and the SMS database email content tables. A completed email consists of a sender name, addressee name, addressee email address, email subject, body, User ID and footer. The program constructs the email and transfers it to a standard web mail server for transmission. The program also updates the SMS user table with the sent email code and date of sending. This information will be used by the Reminder Agent 52 to calculate when a reminder email is sent. The SMS email agent 57 also appends a new record to the SMS database History table 62c that includes the User ID, the Email Code, and the current date.

The SMS Administrator 55 system is a web application consisting of ASP pages, Html pages, and database queries that is used by provider's account management personnel to (a) monitor the training, (b) release Emails from the Email Queue, and (c) update user, curriculum, company and course information in the SMS data tables. Access to the SMS administrator is protected by a two-factor user authentication system that requires a password and a USB token containing an encrypted EEPROM memory chip containing the SMS user's private credentials.

The SMS Reporting System is a web application that runs on the Reporting server 43 to produce reports of user training activity. Access is restricted by a two factor user authentication system as used in the SMS Administrator. The system uses a report generator such as Crystal Reports and a set of predefined database queries to the SMS data tables. A predefined series of reports are prepared for each company at the end of each month by the system and stored on the reporting server 43. These reports contain both monthly and cumulative activity. The Reporting System includes a web application to permit copies of these reports to be downloaded by either the provider or approved company personnel. The Reporting system contains another web application to allow the real-time creation of reports. These reports are viewed, printed or downloaded in any of a variety of formats including PDF format, Excel format, and print format. Copies of real-time reports are not stored on the Report server.

FIG. 3 shows the basic steps involved in training delivery including the systems that are utilized to execute those steps, the basic processing flow, any sub-processing flows that are required and the data content that is required at various processing steps. At the start of the process, the enrollment agent 50 assembles and sends an appropriate enrollment e-mail 51 to the trainees 12 that have been identified to the course designer for receiving training. The enrollment agent 50 checks to ascertain if is the trainee 12 has signed on to the website and enrolled to take a course within a specified time frame, all as determined by the group e-mail content data 74, which identifies the various trainees 12, when they are to take the training, and the training that they are intended to receive. If the trainee 12 has not signed-on and enrolled, the Reminder Agent 52 generates a reminder e-mail 64 to the trainee 12 requesting the trainee 12 to take the training. The content of the enrollment e-mail 51 and the reminder e-mail 64 are derived from the group e-mail content 74. Once the trainee 12 signs-on to the system and logs in, identifying himself or herself and being recognized by the system 10, the system 10 recognizes trainee 12 by name and/or serial number or other such identifier, e.g., email “handle”. The system 10 then begins assembling the specific course curriculum and course content and email communications that have been designed for that specific trainee. The present invention preferably has a plurality of modes of presentation. For example, the trainee 12 may select between receiving the course in either text or audio and may select different modes on different courses. The employee may also be able to select receiving the translations in languages other than English, where available. A moving video option may be made available for those trainees equipped with computers and Internet connections capable of handling a video stream. In each case, e.g., in a silent, text-only mode or in a text-plus-audio mode, the necessary components for presenting a custom course to the specific trainee 12 are called from storage on data server 33 by the application server 42 and presented to the trainee 12 as the trainee 12 interacts with the course. The first portion of this specific content is the Portal Page 94 as specified by Portal Customization 96. Custom content 98 is employed to generate the Portal Page 94 including the client logo, CEO or other executive message, etc., 100 as defined by the client representative 17 in conjunction with the compliance expert 19. A sample portal page 94, as shown in FIG. 4 would include the identifying logo of the client, a welcoming message and other portal data 100 that the client representative 17 wishes to appear on the portal 94. The concept of generating a unique portal 94 specific to the client that employs the trainee 12 is to assure trainee 12 that the training is sponsored and approved by the client and in general, supporting their confidence in the training and in the ethics and compliance program. As can be seen in FIG. 4, the portal page 94 may contain several links 102, e.g., linking to additional pages of text and images for describing the client's Code of Conduct, Compliance Help Line, Contacts and a Client Policy Manual. At the portal page 94, the trainee 12 can opt to click links to read a message from the CEO (or other company executive) 104, take the course specified 106 in their Welcome email or to take other courses 108. Once the trainee 12 selects a particular course 106, 108 to take, the trainee 12, is at that point, engaged in enrollment 76, invoking the Remora or Standard Course 110 and associated data 112 which is also applicable to an optional course 78. The data underlying the training is provided on data server 33. The library content 120 and customization 118 is utilized to present an Introduction & Story 116. The Dynamic Customization 38 is invoked via the course Topic Menu 124 as shown in FIG. 5. The Topic Menu 124 breaks the course down into several manageable topic segments 126, both from the standpoint of time and comprehension, to promote the convenient and modularized delivery of training that can be incorporated easily into a trainee's 12 schedule. The trainee 12 may participate in the course over several sittings, and may return to the course at a later time and will be given the option of starting at the beginning or at the point at which the trainee left off at the last sitting. As shown in FIG. 5, the topic segments 126 include an image 128 and a brief identification and story synopsis 130 for each topic 126. The bookmarking system 83 maintains a record of which topics 126 have been reviewed by the trainee 12 and puts a checkmark 132 beside each topic 126 that has been reviewed. This allows the trainee 12 to readily ascertain where he or she left off when they sign on again to finish additional topics 126 in the course. In addition, the bookmarking system 83 maintains a record of the completion of the course by the trainee 12. Upon selecting a topic 126 from the Topic Menu 124 shown in FIG. 5, e.g., the topic 126 labeled “Trade Association Dangers,” pages of text, images and/or audio segments associated with that topic are then presented to the trainee 12 for their review. FIG. 6 shows an introductory screen 136 giving instructions for taking the course, some rule content and displaying control buttons 138a-138f. Each topic 126 has an associated story line or fact scenario in which the training topic is illuminated by way of an example which may include, for example, a discussion between fictional characters relating to the topic at issue. This story is accessed by clicking on control button 138a. Another control button, the “Take Note” button 138b links to bullets of information presented in a didactic fashion, viz., direct exposition of a principle or rule. The “Q&A” button 138c poses questions to the trainee 12, along with the appropriate answers. The “Checkpoint Question” button 138d calls up a multiple choice quiz question. The “Right Way” button 138e presents a version of the story in which the characters handle the fact pattern in the proper manner, illustrating the correct application of the rules to be learned in the training session. The presentation of training is generally sequential, but is controlled by the trainee 12, who, based upon their instructional needs, can stop a lesson, review content or inquire further into a particular issue by way of referring to Library information, etc. It should be appreciated that each of the foregoing elements of training, be it a topic 126, a “Take Note!”, a Q&A, etc., are all assembled dynamically for the specific trainee 12, e.g., the Take Note and Q&A sessions are assembled dynamically by the system from data 140 to provide the correct instruction for the specific trainee 12 or the group that the trainee 12 has been placed into. After reviewing all the topics 126 and exercising all the control buttons 138a-138f for each topic 126, a conclusion 142 is presented to the trainee, which indicates the final disposition of the characters and the rules that should have been learned from their particular fictional experiences. The Test-to-100% system 82 then administers a Final Test 146 drawing from test content 148. Multiple questions are asked of the trainee 12 and if the trainee answers correctly, they are provided with a certificate of course completion and a congratulatory (Completion) email 60 using Group Email Content 152 as an indication that they have successfully completed the course. In the event that the trainee 12 has failed to answer any question correctly, the test results are reported to the trainee 12, indicating which questions were answered correctly and which questions were answered incorrectly. Remediation 150 directed at teaching the trainee 12 the information needed to pass the test to 100% is undertaken. Review pointers are provided for each failed question and the trainee 12 is re-tested on that subject area until the trainee succeeds in passing all questions correctly. A completion agent 54 then attends to sending a completion e-mail 60 to the trainee 12 and/or their employer utilizing the data from the group e-mail content 152 in the database 18.

This disclosure contains material subject to copyrights, which the owner reserves and retains.

It should be understood that the embodiments described herein are merely exemplary and that a person skilled in the art may make many variations and modifications without departing from the spirit and scope of the invention as defined in the appended claims. All such variations and modifications are intended to be included within the scope of the present invention as defined in the appended claims.

1. A system for providing training over a network, comprising:
a. a database for holding training data, a subset of said training data being targeted data for teaching at least one specific trainee having a specific training need;
b. a server computer connected to the network and having access to the training data in the database; and
c. said system identifying trainees who connect to the system to obtain training, the identity of whom triggers the extraction of the targeted data from the database and the presentation of the targeted data by the server to train the specific trainee identified.

2. The system of claim 1, wherein the specific training need is to avoid risk, said targeted data being selected based upon risk exposure data to provide training that will allow said specific trainee to avoid risk by applying the training.

3. The system of claim 2, wherein the training data is dynamically retrieved and presented to the specific trainee as the specific trainee takes the training.

4. The system of claim 3, wherein the training data dynamically retrieved and presented to the specific trainee includes at least a portion of said targeted data.

5. The system of claim 4, wherein the training data includes at least one of text, audio, image, and video data.

6. The system of claim 5, wherein said training data is in a plurality of discrete segments and the presentation timing of the discrete elements is at least partially under the control of the specific trainee.

7. The system of claim 6, wherein the presentation of said training data is at least partially in response to the selection of a displayed link.

8. The system of claim 7, wherein at least a portion of said targeted data is presented in response to the selection of a displayed link.

9. The system of claim 7, where at least a portion of said targeted data is displayed without the selection of a displayed link.

10. The system of claim 2, further comprising a testing system for testing trainees who take the training offered by the system.

11. The system of claim 10, wherein said testing system utilizes questions randomly selected from a list of questions.

12. The system of claim 11, wherein the testing criteria is 100% accuracy in answering test questions.

13. The system of claim 12, wherein the testing conducted by said testing system includes notification to the trainee of right and wrong answers.

14. The system of claim 13, wherein said testing system provides remedial lesson data to trainees to teach subject matter relating to a wrongly answered question.

15. The system of claim 14, wherein said testing system includes retesting on wrongly answered questions.

16. The system of claim 15, wherein questions posed on retesting inquire into the same subject areas of prior failed questions, but are reformatted so as not to duplicate a prior failed question.

17. The system of claim 2, further comprising a tracking system for tracking and recording the identity of training data that has been reviewed by each specific trainee.

18. The system of claim 17, wherein said tracking system provides an indicator to the trainee to show the content of training data that has already been reviewed by the trainee.

19. The system of claim 18, wherein said tracking system ascertains that the trainee has successfully completed the training intended for the trainee and conveys confirmation to the trainee that they have successfully completed training.

20. The system of claim 19, wherein the ascertainment of completion of training is conducted by a programmatic completion agent.

21. The system of claim 17, further comprising a timer for timing the rate at which a trainee proceeds through said training data and incentivizes the trainee to review said training data at a selected pace to promote comprehension thereof.

22. The system of claim 17, wherein said tracking system notifies an employer of the trainee as to the status of the trainee's review of said training data.

23. The system of claim 2, further comprising a subscription management system, said subscription management system including an SMS database of trainee data and means for searching the database of trainee data to ascertain what particular training is required for each trainee and for sending the trainees emails to incentivize them to take the training.

24. The system of claim 23, wherein said means for searching includes a programmatic enrollment agent that evaluates when a trainee should be enrolled in a particular course of training by examining information in the database about the trainee's risk group, curriculum, and previous training.

25. The system of claim 24, wherein the enrollment agent modifies data in the SMS database tables to trigger the preparation of an email to be sent to the trainee and the modification of the trainee data so as to locate and display the newly enrolled training information when the trainee logs in to the system.

26. The system of claim 23 wherein, said SMS database further includes data about trainees, courses, course curriculums, risk groups, course customization and email content.

27. The system of claim 23, wherein said SMS database contains a schedule for taking training and said emails are sent to promote the trainee to take the training in accordance with the schedule.

28. The system of claim 27, wherein said emails have content stored and targeted at least one specific trainee.

29. The system of claim 2, further comprising a programmatic email agent for sending emails to trainees.

30. The system of claim 29, wherein the emails sent by the email agent are composed from information in an email queue and from information stored in tables of the Subscription Management System.

31. The system of claim 30, wherein the email address is verified and the content and date of emails sent is stored in a database table.

32. The system of claim 2, wherein the training data includes portal data for presenting a customized portal.

33. The system of claim 32, wherein the custom portal displays portal data showing sponsorship of the training by an entity having a relationship to the specific trainee.

34. The system of claim 33, wherein said portal data includes at least one of an employer's policies, procedures and ethics and compliance programs.

35. The system of claim 33, wherein said custom portal provides access for the trainee to enter a next assigned course of training data in a curriculum.

36. The system of claim 33, wherein said custom portal provides access for the trainee to enter optional courses of training data preselected for the trainee.

37. The system of claim 2, wherein said training data includes a plurality of standard courses.

38. The system of claim 37, wherein said training data includes at least one standard course that has been partially modified to constitute a Remora Course.

39. The system of claim 38, wherein said training data includes custom content displayed to a specific trainee when at least one of said standard courses and said Remora Course is viewed.

40. The system of claim 2, wherein said at least one specific trainee is a plurality of trainees, a portion of whom have similar training needs and wherein this portion is grouped, such that each of the persons in this portion receive the same training data.

41. The system of claim 2, wherein the specific training need is to avoid ethics and compliance risk, said targeted data being selected by compliance experts.

42. The system of claim 2, further comprising a subscription management system administrator program for controlling training data that is available to a trainee, when it is available and the content of emails to be sent to the trainee.

43. A method for providing training over a network, comprising the steps of:
a. identifying general training data for training trainees on a selected topic;
b. considering the particular characteristics of at least one specific trainee and identifying specific training data that will reduce the risk of non-compliance of that specific trainee;
c. storing the general training data and the specific training data in a database;
d. providing a server computer connected to the network and having access to the database; and
e. presenting the general training data and the specific training data to the trainee over the network.

44. The method of claim 43, further including the step of monitoring the training activities of trainees by storing information about the trainee's completion of training material in a database.

45. The method of claim 44, further comprising the step of communicating with the trainees to incentivize them to take training.

46. The method of claim 45, further comprising the step of testing the trainee on their comprehension of the training data.

47. The method of claim 46, wherein during the step of testing the trainee is asked to click on the correct button containing text of the most correct answer from a number of possible answers to a displayed question.

48. The method of claim 47, further comprising the step of evaluating if the trainee clicked on the correct button and storing such evaluation to determine if the trainee answered all questions correctly so as to have a test score of 100% after all questions are complete.

49. The method of claim 48, further including the step of displaying the question numbers of the questions answered incorrectly and providing remedial training data to the trainee for information the trainee has failed to comprehend as discerned by said step of testing.

50. The method of claim 49, further comprising the step of retesting the trainee on topics previously failed by the trainee by repeating all questions not previously answered correctly by trainee but in so doing not repeating those questions that the trainee did correctly answer previously.

51. The method of claim 50 where the retesting step is repeated until the trainee has answered all questions correctly.

52. The method of claim 51, further comprising the step of storing data in the database to indicate that the trainee has completed all sections of the material and answered all test questions correctly, noting when this occurred.

53. The method of claim 52, further comprising the step of automatically generating an email to a recipient indicating that the trainee has completed training.

54. The method of claim 47, wherein the answers displayed for each question in the testing are displayed in a random order each time the testing is conducted.

55. The method of claim 46, further including the step of providing remedial training data to the trainee for information the trainee has failed to comprehend as discerned by said step of testing.

56. The method of claim 55, further comprising the step of retesting the trainee on topics previously failed by the trainee.

57. The method of claim 35, wherein the standard for testing is 100%.

58. The method of claim 35, wherein said step of testing includes randomly selecting test questions from a list of possible questions.

59. The method of claim 34, wherein said step of communicating includes sending emails to the trainee.

60. The method of claim 44, further comprising the step of displaying a message to the trainee if they attempt to exit a section of the training course without viewing all information required for the satisfactory completion of that section.

61. The method of claim 60, wherein the message displayed indicated the specific information that has not been satisfactorily completed.

62. The method of claim 44, further comprising the step of timing the rate at which trainees view training data and comparing such rate against a previously determined minimum time value.

63. The method of claim 62, further comprising the step of displaying a message to the trainee that their rate of training is less than the minimum time value and requiring the trainee to spend additional time viewing the training data before they are able to continue to the next topic.

64. The method of claim 44, further comprising the step of displaying a series of indicators such as a “checkmark” to indicate to the trainee which parts of the course have been completed when the trainee signs on later.

65. The method of claim 43, wherein said step of considering includes reviewing data related to risk exposure of the specific trainee and said step of presenting includes presenting training to avoid risk.

66. The method of claim 65, wherein said step of presenting includes dynamically retrieving and presenting general and specific training data from the database.

67. The method of claim 66, further including the steps of developing and displaying training control options to the trainee and associating the training control options with portions of at least one of the general and specific training data and wherein said step of presentation includes displaying the training control options to the trainee and providing at least one of said general and specific training data to the trainee in response to selecting a training control option.

68. The method of claim 67, wherein said step of presentation includes presenting at least one of said general and specific training data absent a selection of a training control option.

69. The method of claim 43, further comprising the step of scheduling training for trainees.
